(19) United States
(12) Patent Application Publication
(10) Pub. No.: US 2011/0196734 A1
(43) Pub. Date: Aug. 11, 2011

(54) TECHNIQUE FOR RECOMMENDING ADVERTISING MESSAGES

(75) Inventors: Nicholas R. Anderson, San Francisco, CA (US); Ben Ross, San Francisco, CA (US); Christopher W. Phillips, Kensington, CA (US); Tonya M. Rado, Tiburon, CA (US); Manish R. Shah, Mountain View, CA (US); Kristina L. Gibson, Toronto (CA)

(73) Assignee: INTUIT INC., Mountain View, CA (US)

(21) Appl. No.: 12/702,890

(22) Filed: Feb. 9, 2010

(51) Int. Cl. G06Q 30/00

(52) U.S. Cl. 705/14.42

(57) ABSTRACT

A technique for identifying a recommended type of advertising message is described. In this technique, information about advertising messages directed from businesses to consumers and associated acceptance rates of the advertising messages by the consumers is received or accessed. Note that the advertising messages include different types of advertising messages for different types of businesses. Then, the recommended type of advertising message for a given business is identified based on an associated type of business and the received information. By leveraging the results obtained by other similar businesses, this technique may allow the given business to improve the effectiveness of a subsequent advertising campaign.

### BACKGROUND

The present disclosure relates to techniques for recommending types of advertising messages to a business.

One of the keys to a succeeding in business is to increase revenue. A variety of techniques are used to achieve this objective, including advertising messages (such as commercials or advertisements) and promotions (such as coupons), which are henceforth referred to as ‘advertising messages.’ The goals of the advertising messages are to increase customer loyalty and to attract new customers.

In principle, many different types of advertising messages can be distributed. However, it is often difficult for businesses to assess the effectiveness of a given type of advertising message prior to conducting an advertising campaign. Consequently, businesses often use focus groups to predict the effectiveness of different types of advertising messages. In addition, the impact of a given advertising message may be assessed during an advertising campaign, and the given advertising message may be modified accordingly.

While these prediction and feedback techniques can improve the effectiveness of different types of advertising messages, they are often inefficient. For example, the information obtained from focus groups is often inaccurate. Moreover, waiting for feedback until after an advertising campaign has started can result in unnecessary expense and delay. Waiting for feedback also has an opportunity cost, because if the advertising messages used in an ongoing advertising campaign turn out to be ineffective, existing customers and prospective new customers may be lost.

### SUMMARY

The disclosed embodiments relate to a computer system that identifies a recommended type of advertising message. During operation, the computer system receives information regarding advertising messages directed from businesses to consumers and associated acceptance rates of the advertising messages by the consumers, where the advertising messages include different types of advertising messages for different types of businesses. Then, the computer system identifies the recommended type of advertising message for a given business based on an associated type of business and the received information. For example, the recommended type of advertising message may be identified based on a variety of factors, including: a time, a date, a location of the business, and/or demographic characteristics of existing customers of the business.

Note that the advertising messages may include information associated with financial incentives, such as discounts or coupons. In some embodiments, the advertising messages include text messages sent to portable electronic devices, such as cellular telephones.

In some embodiments, the computer system provides information that specifies the recommended type of advertising message to the business. Moreover, the computer system may receive feedback from the business regarding the recommended type of advertising message. Then, the computer system may provide additional advertising messages to one or more of the consumers based on the recommended type of advertising message and the feedback. For example, the feedback may indicate acceptance of the recommended type of advertising message. Alternatively or additionally, the feedback may provide or specify one or more rules for an advertising campaign, and the additional advertising messages may be dynamically provided based on the one or more rules.

In some embodiments, the computer system receives responses from the one or more consumers to the additional advertising messages, which are subsequently used to identify a recommended type of advertising message for another business based on an associated type of business of the other business.

Another embodiment provides a method that includes at least some of the operations performed by the computer system.

Another embodiment provides a computer-program product for use with the computer system. This computer-program product includes instructions for at least some of the operations performed by the computer system.

### BRIEF DESCRIPTION OF THE FIGURES

FIG. 1 is a flow chart illustrating a method for identifying a recommended type of advertising message in accordance with an embodiment of the present disclosure.

FIG. 2 is a drawing of a user interface in accordance with an embodiment of the present disclosure.

FIG. 3 is a block diagram illustrating a computer system that performs the method of FIG. 1 in accordance with an embodiment of the present disclosure.

FIG. 4 is a block diagram illustrating a computer system that performs the method of FIG. 1 in accordance with an embodiment of the present disclosure.

FIG. 5 is a block diagram illustrating a data structure for use in the computer system of FIG. 4 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for identifying a recommended type of advertising message, and a computer-program product (e.g., software) for use with the computer system are described. In this technique, information about advertising messages directed from businesses to consumers and associated acceptance rates of the advertising messages by the consumers is received or accessed. Note that the advertising messages include different types of advertising messages and the businesses include different types of businesses. Then, the recommended type of advertising message for a given business is identified based on an associated type of business and the received information.

By leveraging the results obtained by other similar businesses, this message-identification technique may solve the problems of ineffective advertising campaigns and the inefficiencies associated with existing feedback techniques. In particular, by using the market experiences of a group of similar businesses, the message-identification technique may allow the given business to use the type of advertising message that has the maximum likelihood of success with a given customer. For example, this approach may allow the given business to retain existing customers and attract new customers in a cost-effective and timely manner.

In the discussion that follows, ‘business’ should be understood to include a variety of entities, including: for-profit corporations, non-profit corporations, organizations, groups of individuals, sole proprietors, governmental agencies, partnerships, etc. Similarly, a ‘consumer’ should be understood to include an entity (such as an individual, a group of individuals, an organization, another business, etc.) that has a relationship with the business, either as a business partner (a supplier or vendor) or a customer of a product or service provided by the business. Moreover, an ‘advertising message’ should be interpreted broadly to include a message that includes text, audio and/or video information for the purpose of retaining an existing customer of the business, attracting a new customer of the business and, more generally, for expanding the brand awareness of the business in the marketplace.

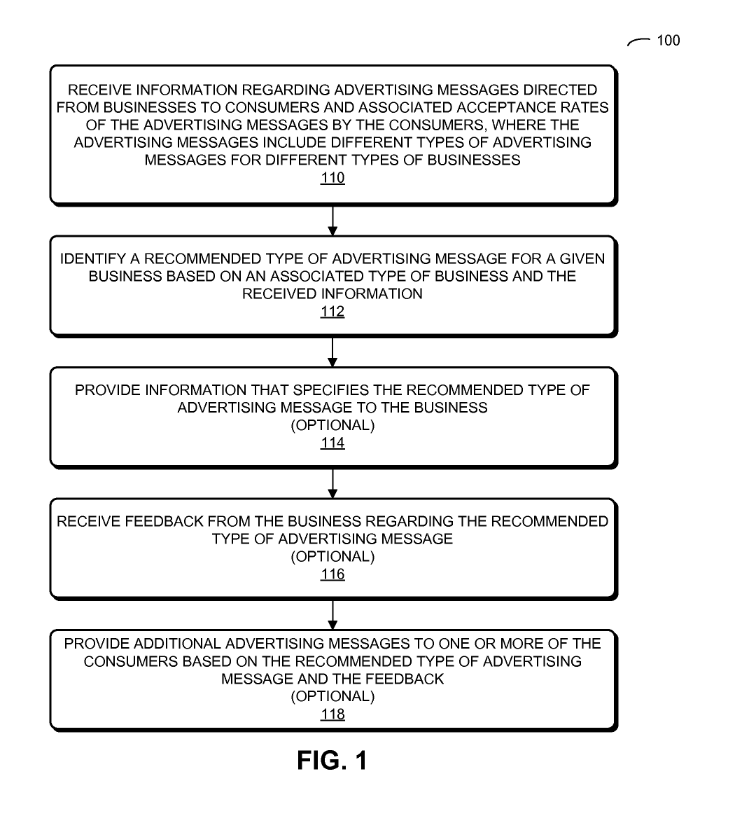

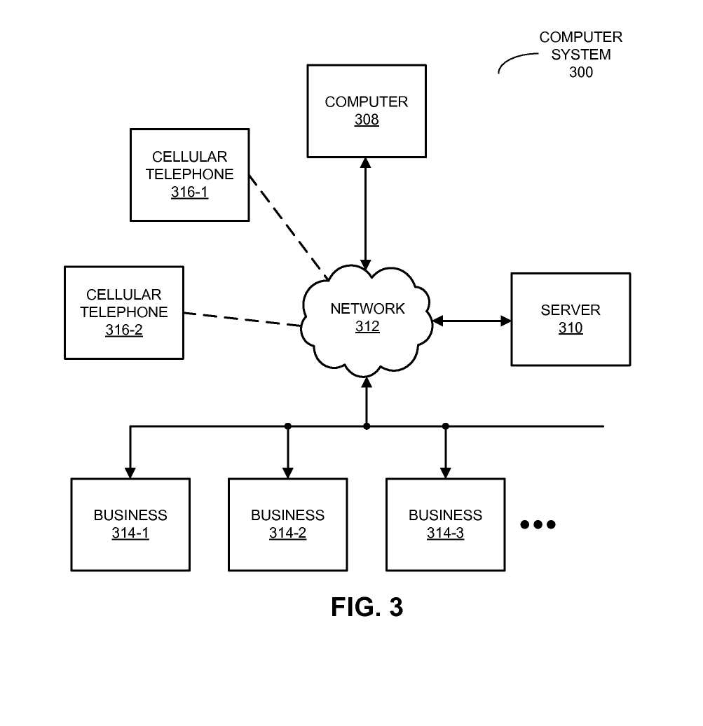

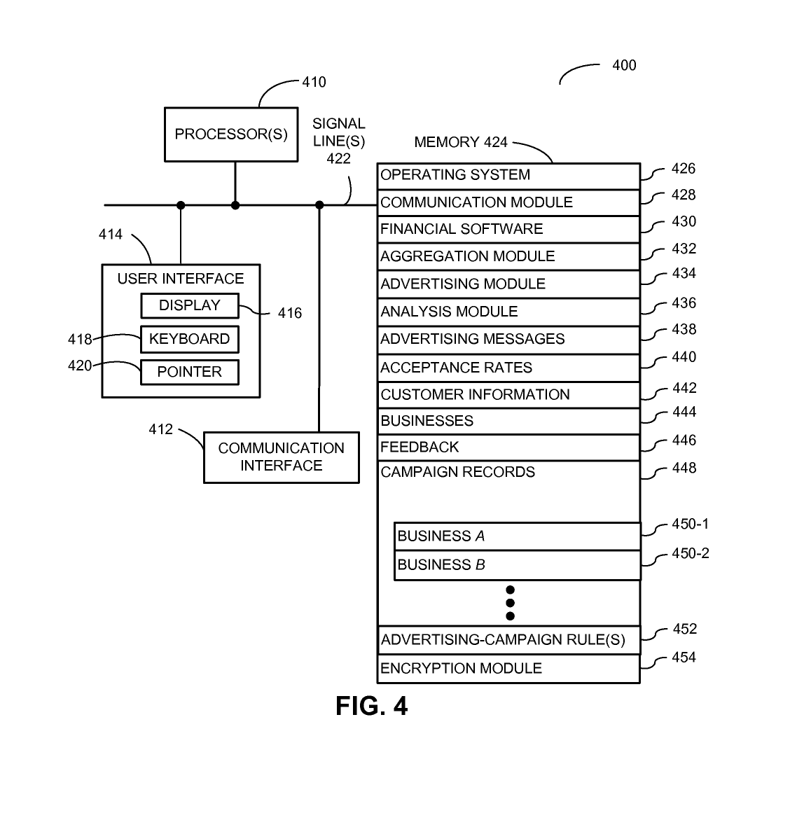

We now describe embodiments of the message-identification technique. FIG. 1 presents a flow chart illustrating a method 100 for identifying a recommended type of advertising message, which may be performed by a computer or a computer system (such as computer system 300 in FIG. 3 and/or computer system 400 in FIG. 4). During operation, the computer system receives information regarding advertising messages directed from businesses to consumers and associated acceptance rates of the advertising messages by the consumers (operation 110), where the advertising messages include different types of advertising messages for different types of businesses. Then, the computer system identifies the recommended type of advertising message for a given business based on an associated type of business and the received information (operation 112). For example, the recommended type of advertising message may be identified based on a variety of factors, including: a time, a date, a location of the business, and/or demographic characteristics of existing customers of the business.

Note that the advertising messages may include information associated with financial incentives, such as discounts or coupons. As shown below with reference to FIG. 3, the advertising messages may include text messages sent to portable electronic devices, such as cellular telephones.

In some embodiments, the computer system optionally provides information that specifies the recommended type of advertising message to the business (operation 114). Moreover, the computer system may optionally receive feedback from the business regarding the recommended type of advertising message (operation 116). Then, the computer system may optionally provide additional advertising messages to one or more of the consumers based on the recommended type of advertising message and the feedback (operation 118). For example, the feedback may indicate acceptance of the recommended type of advertising message. Alternatively or additionally, the feedback may provide or specify one or more rules for an advertising campaign, and the additional advertising messages may be dynamically provided based on the one or more rules.

In some embodiments of method 100, there are additional or fewer operations. For example, the computer system may optionally receive responses from the one or more consumers to the additional advertising messages, which are subsequently used to identify a recommended type of advertising message for another business based on an associated type of business of the other business. Moreover, the order of the operations may be changed and/or two or more operations may be combined into a single operation.

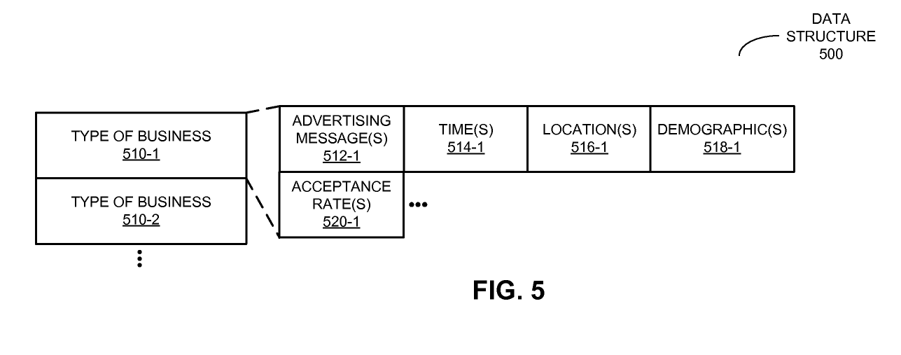

In an exemplary embodiment, the message-identification technique helps the business increase sales using targeted offers and personalized solutions for consumers, for example, by identifying and sending targeted advertising message(s) to the consumers using text messages. In particular, as shown in FIG. 5, a data structure with information about different types of advertising messages that were offered by different types of business may be collected (for example, by tracking the advertising messages that were offered by businesses and the associated consumer responses). Note that the information may include: demographic information about the targeted consumers, timing of the advertising messages, locations of the consumers when the advertising messages were provided, and/or acceptance rates of the different types of advertising messages.

Using the data structure, the types of advertising messages (e.g., ‘buy one get one free,’ ‘15% off,’ ‘free visit on your birthday,’ etc.) that are most successful (i.e., that have the highest acceptance rates, such as acceptance rates greater than 65%) for different types of businesses (such as restaurants, stores, car mechanics, hair salons, service providers, etc.) can be identified. For example, the information in the data structure can be fit using a supervised learning technique (such as regression analysis) based on the known acceptance rates to provide a function (or a look-up table) that predicts the type of advertising message as a function of the type of business, as well as timing, location and/or demographic information for the consumer (i.e., the recipient of the type of advertising message). As is known in the art, a wide variety of supervised learning techniques can be used, including linear and/or non-linear models (such as a support vector machine and a classification and regression tree).

Based on the determined function (or the look-up table), the type of advertising message for a given type of business can be identified. In essence, the determined function allows the type of advertising message to be post-dicted based on the market experience of other businesses in the same or similar types of business or business categories. For example, for a particular business in the given type of business (such as a ‘hair salon’), the determined function may indicate that a particular type of advertising message has a 77% acceptance rate. Moreover, as noted above, the type of advertising message can also be tailored based on a time of day, the date, a location and/or the demographic information associated with one or more consumers.

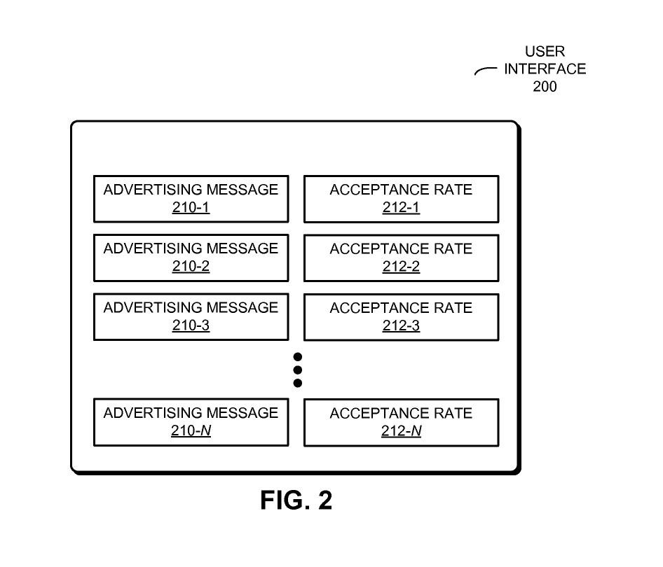

The various types of advertising messages may be presented to a user (such as a small business person) using a user interface. This is shown in FIG. 2, which presents a drawing of a user interface 200 that may be displayed on a computer or computer system (such as computer system 300 in FIG. 3 or computer system 400 in FIG. 4). In this user interface, the user may be able to select from several different types of advertising messages 210, such as: a birthday message (‘Happy Birthday! Celebrate your birthday with us and get 15% off.’), an anniversary message (‘Happy Anniversary! Treat your spouse to a gift from us. Spend over $20 and get 10% off.’), a tell-a-friend message (‘Tell a friend about us! Both you and your friend will receive 15% off your next purchase.’), a holiday message (‘Happy New Year! Please come celebrate with us. Buy one item over $20 and get a second item free.’), and/or a thank-you message (‘Thank you for visiting us—we hope it was enjoyable. Please come back and get 10% off your next bill.’). Furthermore, each of the different types of advertising messages 210 may have an associated acceptance rate 212 for the type of business associated with the user. Additionally, note that each of the different types of advertising messages 210 may have an associated template (with the offer name, the offer details, etc.).

Using this user interface, the user may configure an advertising campaign. For example, the user may select one or more of the identified types of advertising messages 210 and/or may provide rules for the advertising campaign (such as a preferred targeted consumer, a total budget for the advertising campaign, etc.). In addition, in some embodiments the user may be able to customize the identified types of advertising messages 210 (such as the offer name, the offer details, and/or targeted consumers or groups of consumers) using the associated templates as a starting point.

Then, based on the user feedback, advertising messages may be provided to consumers. For example, an advertising message provided to the cellular telephone of a given consumer may be dynamically determined based on the user-specified rules for the advertising campaign, the time, the date, the consumer location, etc.

As the advertising campaign proceeds, the user may receive regular updates regarding the efficacy of the offers (e.g., the current acceptance rate(s)), which can help the user determine whether or not to modify the advertising campaign. In addition, the data structure can be revised to include the ongoing results of the user's advertising campaign.

We now describe embodiments of the computer system and its use. FIG. 3 presents a block diagram illustrating a computer system 300 that performs method 100 (FIG. 1). In this system, a user of computer 308 may use advertising software to design and implement an advertising campaign. For example, via network 312, the user may access a web page that is provided by server 310 using a web browser that is installed and which executes on computer 308. Alternatively or additionally, the user may use an advertising-software application that is resident on and that executes on computer 308. This advertising application may be a stand-alone application or a portion of another application that is resident on and which executes on computer 308. Note that in some embodiments the advertising software is associated with financial software that is used by the user.

In some embodiments, at least a portion of the advertising-software application may be an application tool (such as an advertising-software application tool) that is embedded in the web page (and which executes in a virtual environment of the web browser). In an illustrative embodiment, the advertising-software application tool is a software package written in: JavaScript™ (a trademark of Sun Microsystems, Inc.), e.g., the advertising-software application tool includes programs or procedures containing JavaScript instructions, ECMAScript (the specification for which is published by the European Computer Manufacturers Association International), VBScript™ (a trademark of Microsoft, Inc.) or any other client-side scripting language. In other words, the embedded advertising-software application tool may include programs or procedures containing: JavaScript, ECMAScript instructions, VBScript instructions, or instructions in another programming language suitable for rendering by the web browser or another client application (such as on computer 308). Thus, the advertising-software application may be provided to the user via a client-server architecture.

As discussed previously, based on one or more factors (such as a type of business associated with the user), the advertising software may identify different types of advertising messages that have high acceptance rates. In particular, the data structure with the information for previous advertising campaigns conducted by businesses 314 may be accessed, and the different types of advertising messages may be identified.

Then, the identified types of advertising messages may be presented to the user (for example, in a user interface displayed on computer 308) so that the user can select one or more of the advertising messages and/or can provide feedback about the advertising messages (such as rules for an advertising campaign or customization of the selected advertising messages). Next, the advertising software may conduct the advertising campaign (i.e., it may provide advertising messages to consumers). For example, text messages or short-message service (SMS) messages may be communicated to consumer's cellular telephones 316 via network 312. Furthermore, consumer responses to these text messages may be received from cellular telephones 316 by server 310 using network 312. These responses may be used to revise or update the data structure. In this way, there may be bi-directional engagement, for both capture and delivery of the text messages to cellular telephones 316.

As the advertising campaign progresses, updates about the advertising campaign may be displayed to the user on computer 308. In addition, the ongoing results of the advertising campaign can be added to the data structure. Note that the information in computer system 300 (such as the data structure) may be stored at one or more locations in computer system 300 (i.e., locally or remotely). Moreover, because this information may be sensitive in nature, it may be encrypted. For example, stored information and/or information communicated via network 312 may be encrypted.

FIG. 4 presents a block diagram illustrating a computer system 400 that performs method 100 (FIG. 1), such as server 310 (FIG. 3). Computer system 400 includes one or more processors 410, a communication interface 412, a user interface 414, and one or more signal lines 422 coupling these components together. Note that the one or more processing units 410 may support parallel processing and/or multi-threaded operation, the communication interface 412 may have a persistent communication connection, and the one or more signal lines 422 may constitute a communication bus. Moreover, the user interface 414 may include: a display 416, a keyboard 418, and/or a pointer 420, such as a mouse.

Memory 424 in computer system 400 may include volatile memory and/or non-volatile memory. More specifically, memory 424 may include: ROM, RAM, EPROM, EEPROM, flash memory, one or more smart cards, one or more magnetic disc storage devices, and/or one or more optical storage devices. Memory 424 may store an operating system 426 that includes procedures (or a set of instructions) for handling various basic system services for performing hardware-dependent tasks. Memory 424 may also store procedures (or a set of instructions) in a communication module 428. These communication procedures may be used for communicating with one or more computers and/or servers, including computers and/or servers that are remotely located with respect to computer system 400. While not shown in FIG. 4, in some embodiments memory 424 includes a web browser.

Memory 424 may also include multiple program modules (or sets of instructions), including: financial software 430 (or a set of instructions), aggregation module 432 (or a set of instructions), advertising module 434 (or a set of instructions), analysis module 436 (or a set of instructions), and/or encryption module 454 (or a set of instructions). Note that one or more of these program modules (or sets of instructions) may constitute a computer-program mechanism.

During operation, aggregation module 432 may collect the results of advertising campaigns of businesses 444 in campaign records 448, such as the advertising campaign results for business A 450-1 and business B 450-2. Subsequently, when a given user is using advertising module 434, one or more of advertising messages 438 may be identified. In particular, analysis module 436 may identify one or more of advertising messages 438 based on a variety of factors, such as: acceptance rates 440, customer information 442 and/or information in campaign records 448.

These identified advertising messages 438 may be presented to the user (for example, on display 416), and user feedback 446 about these advertising messages 438 may be received (such as one or more user selections or changes to the identified advertising messages). In addition, the user may provide one or more advertising-campaign rules 452.

Next, advertising module 434 may conduct the requested advertising campaign for the user. For example, advertising module 434 may provide advertising messages to consumers, and may receive their responses (if any) via communication module 428. During the advertising campaign, advertising module 434 may update the user about the campaign (such as acceptance rates 440 of different advertising messages) and/or aggregation module 432 may update campaign records 448.

In some embodiments, at least some of the information stored in memory 424 and/or at least some of the information communicated using communication module 428 is encrypted using encryption module 454. Furthermore, in some embodiments one or more of the modules in memory 424 may be included in financial software 430.

Instructions in the various modules in memory 424 may be implemented in: a high-level procedural language, an object-oriented programming language, and/or in an assembly or machine language. Note that the programming language may be compiled or interpreted, e.g., configurable or configured, to be executed by the one or more processing units 410.

Although computer system 400 is illustrated as having a number of discrete items, FIG. 4 is intended to be a functional description of the various features that may be present in computer system 400 rather than a structural schematic of the embodiments described herein. In practice, and as recognized by those of ordinary skill in the art, the functions of computer system 400 may be distributed over a large number of servers or computers, with various groups of the servers or computers performing particular subsets of the functions. In some embodiments, some or all of the functionality of computer system 400 may be implemented in one or more application-specific integrated circuits (ASICs) and/or one or more digital signal processors (DSPs).

Computers and servers in computer systems 300 (FIG. 3) and/or 400 may include one of a variety of devices capable of manipulating computer-readable data or communicating such data between two or more computing systems over a network, including: a personal computer, a laptop computer, a mainframe computer, a portable electronic device (such as a cellular phone or PDA), a server and/or a client computer (in a client-server architecture). Moreover, network 312 (FIG. 3) may include: the Internet, World Wide Web (WWW), an intranet, LAN, WAN, MAN, or a combination of networks, or other technology enabling communication between computing systems.

In exemplary embodiments, the financial-software application (i.e., financial software 430) includes: Quicken™ and/or TurboTax™ (from Intuit, Inc., of Mountain View, Calif.), Microsoft Money™ (from Microsoft Corporation, of Redmond, Wash.), SplashMoney™ (from SplashData, Inc., of Los Gatos, Calif.), Mvelopes™ (from In2M, Inc., of Draper, Utah), and/or open-source applications such as Gnucash™, PLCash™, Budget™ (from Snowmint Creative Solutions, LLC, of St. Paul, Minn.), and/or other planning software capable of processing financial information.

Moreover, the financial-software application may include software such as: QuickBooks™ (from Intuit, Inc., of Mountain View, Calif.), Peachtree™ (from The Sage Group PLC, of Newcastle Upon Tyne, the United Kingdom), Peachtree Complete™ (from The Sage Group PLC, of Newcastle. Upon Tyne, the United Kingdom), MYOB Business Essentials™ (from MYOB US, Inc., of Rockaway, N.J.), NetSuite Small Business Accounting™ (from NetSuite, Inc., of San Mateo, Calif.), Cougar Mountain™ (from Cougar Mountain Software, of Boise, Id.), Microsoft Office Accounting™ (from Microsoft Corporation, of Redmond, Wash.), Simply Accounting™ (from The Sage Group PLC, of Newcastle Upon Tyne, the United Kingdom), CYMA IV Accounting™ (from CYMA Systems, Inc., of Tempe, Ariz.), DacEasy™ (from Sage Software SB, Inc., of Lawrenceville, Ga.), Microsoft Money™ (from Microsoft Corporation, of Redmond, Wash.), Tally.ERP (from Tally Solutions, Ltd., of Bangalore, India) and/or other payroll or accounting software capable of processing payroll information.

User interface 200 (FIG. 2), computer systems 300 (FIG. 3) and/or 400 may include fewer components or additional components. Moreover, two or more components may be combined into a single component, and/or a position of one or more components may be changed. In some embodiments, the functionality of the computer systems 300 (FIG. 3) and/or 400 may be implemented more in hardware and less in software, or less in hardware and more in software, as is known in the art.

We now discuss a data structure. FIG. 5 presents a block diagram illustrating a data structure 500 for use in computer system 400 (FIG. 4). This data structure may include advertising-campaign records for different types of businesses 510. For example, the advertising-campaign records for type of business 510-1 may include: one or more types of advertising message 512-1, one or more times 514-1 when the advertising messages were offered, one or more consumer locations 516-1 where the advertising messages were offered, demographics of the consumers 518-1, and/or one or more acceptance rates 520-1 of the advertising messages.

In some embodiments of data structure 500, there may be fewer or additional components. Moreover, two or more components may be combined into a single component and/or a position of one or more components may be changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for identifying a recommended type of advertising message, comprising:
receiving information regarding advertising messages directed from businesses to consumers and associated acceptance rates of the advertising messages by the consumers, wherein the advertising messages include different types of advertising messages and the businesses include different types of businesses; and
identifying, using a computer, the recommended type of advertising message for a given business based on an associated type of business and the received information.

2. The method of claim 1, wherein the advertising messages include information associated with financial incentives.

3. The method of claim 1, wherein the advertising messages include text messages sent to portable electronic devices.

4. The method of claim 3, wherein the portable electronic devices include cellular telephones.

5. The method of claim 1, wherein the recommended type of advertising message is identified based on a time or date.

6. The method of claim 1, wherein the recommended type of advertising message is identified based on a location of the business.

7. The method of claim 1, wherein the recommended type of advertising message is identified based on demographic characteristics of existing customers of the business.

8. The method of claim 1, wherein the method further includes providing information that specifies the recommended type of advertising message to the business.

9. The method of claim 8, wherein the method further includes:
receiving feedback from the business regarding the recommended type of advertising message; and
providing additional advertising messages to one or more of the consumers based on the recommended type of advertising message and the feedback.

10. The method of claim 9, wherein the feedback indicates acceptance of the recommended type of advertising message.

11. The method of claim 9, wherein the feedback provides one or more rules for an advertising campaign; and
wherein the additional advertising messages are dynamically provided based on the one or more rules.

12. The method of claim 9, wherein the method further includes receiving responses from the one or more consumers to the additional advertising messages, which are subsequently used to identify a recommended type of advertising message for another business based on an associated type of business of the other business.

13. A computer-program product for use in conjunction with a computer system, the computer-program product comprising a computer-readable storage medium and a computer-program mechanism embedded therein for identifying a recommended type of advertising message, the computer-program mechanism including:
instructions for receiving information regarding advertising messages directed from businesses to consumers and associated acceptance rates of the advertising messages by the consumers, wherein the advertising messages include different types of advertising messages and the businesses include different types of businesses; and
instructions for identifying the recommended type of advertising message for a given business based on an associated type of business and the received information.

14. The computer-program product of claim 13, wherein the advertising messages include information associated with financial incentives.

15. The computer-program product of claim 13, wherein the advertising messages include text messages sent to portable electronic devices.

16. The computer-program product of claim 15, wherein the portable electronic devices include cellular telephones.

17. The computer-program product of claim 13, wherein the recommended type of advertising message is identified based on a time or date.

18. The computer-program product of claim 13, wherein the recommended type of advertising message is identified based on a location of the business.

19. The computer-program product of claim 13, wherein the recommended type of advertising message is identified based on demographic characteristics of existing customers of the business.

20. The computer-program product of claim 13, wherein the computer-program mechanism further includes instructions for providing information that specifies the recommended type of advertising message to the business.

21. The computer-program product of claim 20, wherein the computer-program mechanism further includes:
instructions for receiving feedback from the business regarding the recommended type of advertising message; and
instructions for providing additional advertising messages to one or more of the consumers based on the recommended type of advertising message and the feedback.

22. The computer-program product of claim 21, wherein the feedback provides one or more rules for an advertising campaign; and
wherein the additional advertising messages are dynamically provided based on the one or more rules.

23. A computer system, comprising:
a processor;
memory; and
a program module, wherein the program module is stored in the memory and configurable to be executed by the processor, the program module including:
instructions for receiving information regarding advertising messages directed from businesses to consumers and associated acceptance rates of the advertising messages by the consumers, wherein the advertising messages include different types of advertising messages and the businesses include different types of businesses; and
instructions for identifying the recommended type of advertising message for a given business based on an associated type of business and the received information.
